(19) United States
(12) Patent Application Publication
(10) Pub. No.: US 2003/0012599 A1
(43) Pub. Date: Jan. 16, 2003

(54) Markings on roads with a fixed road surface, such as asphalt, concrete or the like for motor vehicles

(76) Inventors: Magnus Wallgren, Kristianstad (SE); Toni Ogemark, Jamestown, NC (US); Peder Ude Moth, Hesselager (DK)

Correspondence Address: LERNER, DAVID, LITTENBERG, KRUMHOLZ & MENTLIK, LLP, 600 SOUTH AVENUE WEST, WESTFIELD, NJ, 07090-1497, US

(21) Appl. No.: 09/896,795

(22) Filed: Jun. 29, 2001

(51) Int. Cl. G08B 1/00

(52) U.S. Cl. 404/14

(57) ABSTRACT

The invention relates to a surface marking for roads with a fixed road surface, such as asphalt, concrete or like receiving surface, which marking essentially comprises resin, thermoplastic polymers, softeners, reflecting material for better reflection of light, and friction material for increasing the friction between the roadway and the vehicle wheels, said marking comprising at least two layers, of which a first, upper layer (1) constitutes a wear layer, and a second, lower layer (2) is made of a heat-activatable adhesive material.

### TECHNICAL FIELD

The present invention relates to road markings, and to their application, on roads which have a fixed road surface, such as asphalt, concrete and the like and which are used by motor vehicles, bicycles and other vehicles, and also by other road users. These road markings are intended to guide and inform traffic and they must therefore be able to be seen, for example by a driver, both in daylight and at night, and in rain or other inclement weather. They are therefore provided at the surface with reflecting material so that light can be reflected, but also with friction material for increasing the friction so that the road markings will have a friction corresponding to that of the surrounding surfacing

### PRIOR ART

The abovementioned road markings have been known for many years now. The reflecting materials used are preferably glass beads or ceramic materials which are embedded in a binder in the marking but which protrude above the surface of the binder so that light can hit them and can be reflected back to the driver of a vehicle. These glass beads and also the binder can have different compositions, but they are preferably made so that they reflect visible or ultraviolet light.

The roadway outside the road markings must have as high a friction as possible in relation to the wheels of the vehicles driving on the road. However, when a road marking generally consisting of paint, thermoplastic or cold plastic with glass beads is applied to the roadway, this results in a lower friction on this marking than on the rest of the road surface, for which reason it is also customary to apply friction-enhancing material in or on the road marking. This material often consists of crushed glass, corundum or other stone material.

In the case of fusible thermoplastics, the friction material and reflecting material in the surface of the road marking can suitably be applied by what is known as the drop-on method (the material is sprinkled on) or with the aid of compressed air and jet nobles. According to the prior art, for example SE-A-9902483-8, the reflecting material can suitably include glass beads and the friction material can suitably include crushed glass, corundum or other stone material. The drop-on method can also be used for road markings of paint or cold plastic, i.e. types of plastic which can be laid on the receiving surface without heating.

Said specification also describes a method for producing road markings of the abovementioned type, which method is characterized in that the friction material is first applied in domains on the marking and thereafter the reflecting material is sprinkled across the whole surface while the latter is still tacky, and the reflecting material does not attach to the domains first sprinkled with friction material, or vice versa. In addition, an arrangement is described for applying reflecting material and friction material in separate domains on a road marking, comprising a machine which can be moved in relation to the receiving surface for sprinkling such materials on, with a rotatable roller which from a material magazine sprinkles the material through a slit, which arrangement is characterized in that the roller is provided with continuous and/or intermittent tracks in the jacket surface. The problem with this type of marking is to achieve an optimum relation between wetting the receiving surface and correct application of the drop-on material. If the wetting is poor, there may be a risk of poor adhesion. If, in order to avoid this, the application temperature is slightly increased, there is instead a risk that the drop-on material will sink too far down in the surface sheet, with reduced or nonexistent retroreflection as a consequence. If the material is optimized for good wetting, it is also possible to end up with a poor result in terms of, for example, wear resistance, and vice versa. For prefabricated markings without any drop-on material on the surface, this material is supplied at the time of application. The final result is then very much dependent on the skill of the person carrying out the application.

Regulating the application temperature for prefabricated thermoplastic road marking material is in principle now only dependent on how quickly the marking is heated. In the case of slow application, a higher temperature is obtained on the underside of the marking compared with rapid application where a high temperature is obtained on the top side, but poor through-heating of the marking.

An alternative way of producing road markings is to apply prefabricated markings in the form of a tape. Such a tape can be made up of several layers, where at least one upper layer has the desired reflecting properties. The tape additionally has a lower layer which as a rule is provided with an adhesive sheet which is either self-adhesive or consists of a pressure-sensitive glue. Known products of this type are sold by companies as 3M™ and, for example, under the name Biltrite™ Series 3000 from the company of the same name.

Tapes of the abovementioned types have, inter alia, problems of adhesion under certain circumstances. In cold climates, self-adhesive material often gives poor adhesion, for which reason many manufacturers do not recommend using them below a certain temperature. There can also be problems with adhesion if a pair of markings overlap each other. Warm climates can instead cause problems with the tape sticking to itself and to other materials. This can affect both the top and the underside. In all circumstances the receiving surface must be well cleaned, for example free from gravel, sand and dust, so that the tape will adhere correctly. For certain types of receiving surfaces, for example concrete, manufacturers recommend that the road surface be given a coating in the form of a primer, or that it must have been driven over by traffic for a certain time to guarantee adhesion.

In addition to the abovementioned problems, tapes with a pressure-sensitive adhesive surface can also be difficult to apply. Upon application, the tape must on the one hand be positioned and on the other hand subjected to the correct pressure in order to activate the adhesive surface. Too little pressure and too much pressure can both cause problems concerning adhesion to the receiving surface.

All types of tapes additionally have problems with adhesion to a rough receiving surface, for example asphalt, with relatively large stone sizes and many cavities.

### DISCLOSURE OF THE INVENTION

The problems associated with today's road markings can be solved with the aid of a marking according to the attached patent claims. The invention relates to a surface marking for roads with a fixed road surface, such as asphalt, concrete or like receiving surface, which marking essentially comprises resin, thermoplastic polymers, softeners, reflecting material for better reflection of light, and friction material for increasing the friction between the roadway and the vehicle wheels.

A characteristic of the invention is that the marking comprises at least two layers, of which a first, upper layer constitutes a wear layer, which among other things contains said reflecting material and friction material, and a second, lower layer is made of a heat-activatable adhesive material. The lower layer preferably has an application temperature which is lower than the application temperature for other layers. Application temperature signifies the temperature to which the marking is heated when it is to be applied to adhere to a receiving surface. The upper layer is heated to a temperature at which it is sufficiently deformable to be able to follow or be shaped according to the lower layer without cracks or other damage occurring. If the upper layer is heated for too long or to too high a temperature, the drop-on material may sink in and/or the surface profile of the layer may be deformed to an undesired extent. A marking intended for use in cold climates has a lower layer with an application temperature which is at most 50% below the application temperature of the upper layer. At the application temperature, the upper layer and any intermediate layers or sheets are formable or plastically deformable, while at least the lower layer is heated to a temperature close to the softening point of the layer so that the marking will be able to adhere to the receiving surface. A slight difference in application temperature may be justified when the application is carried out in warm climates, in which case, if the surrounding temperature is high, it may be possible to use a lower application temperature to obtain good adhesion.

The application temperature is dependent on the softening point of the included binder and on the material's rheology properties. The difference in softening point between the layers should not be too great and instead should be chosen such that good adhesion is obtained both to the receiving surface and also between the layers on a warm day with a high surrounding temperature. A bigger difference in softening point may be justified when the application is carried out in cold climates, in which case, if the surrounding temperature is low, it may be desirable to have a lower softening point in the lower layer in order to obtain good adhesion to a cold receiving surface. In warm climates it may in some circumstances be desirable to have the same softening point and hardness for both layers in order to avoid the marking deforming or changing position when exposed to traffic.

The question of how much the temperatures can be varied and what are the highest and lowest temperatures possible for the different layers depends to a great extent on the choice of material and on the properties the upper layer has been given. In other cases it may therefore be desirable not to heat the upper layer above a certain temperature, so as not to damage it or its properties. Excessive heat upon application may, for example, cause the glass beads in the surface sheet of the layer to sink into the latter or can cause an undesired deformation of a possible surface profile on the marking. By means of different methods of heating the marking, it is possible to some extent to vary the temperature in the lower layer in relation to the upper layer in order to obtain the desired application temperature.

The materials in the different layers are also chosen such that the upper and lower surfaces of the marking are non-tacky within the desired temperature range for the climate for which a particular marking is intended. In cold climates, it may be sufficient for the marking to be non-tacky at temperatures up to 20-30° C., while a marking intended for hot climates must for example be able to withstand temperatures of up to 30-70° C. without becoming tacky. This applies both before and after application of the marking.

The actual application is carried out with the marking being placed on the receiving surface and being heated from the top. Heat can be applied in a number of different ways, for example with a gas burner or the like. In a warm climate, a shorter time is needed for heating than in a cold climate. It is important in this connection that the lower layer of the marking reaches its application temperature. Since the upper layer can cope with a slightly higher temperature than its application temperature for a short period of time, the lower layer can be heated to or slightly above its application temperature without the upper layer being damaged. Although this application method is preferred, it is of course possible to use alternative methods.

By choosing suitable material combinations in each layer it is thus possible to obtain a marking with the desired properties as regards functional characteristics, such as reflection in daylight or under highway lighting, retroreflection on lighting by vehicle headlights in dry and wet conditions, colour, friction, wear resistance, and handling and application characteristics such as flexibility. In principle it is possible to use the same type of material as used in today's markings, but in other ratios in order to obtain the desired properties. A prefabricated marking according to the invention consists of at least two layers, namely:

a lower layer which completely or partially melts in order to be able to pass down into irregularities and pores in the receiving surface for the purpose of obtaining good adhesion by increasing the specific surface area between the marking and the receiving surface. The lower layer contains a softer material which can be slightly compressed, which means that the hard upper layer of the marking can yield slightly, while at the same time it prevents the marking from detaching from the receiving surface;

an upper layer which consists of material which, in addition to said reflecting material and friction material, gives the desired properties as regards wear resistance, for example. This requires a relatively hard material which is able to withstand wearing, blackening and dirtying, and which prevents the reflecting material from being pressed down into the layer on account of the weight of passing vehicles.

A characteristic of the two layers is that the upper layer has a higher softening point, more structural viscosity (pseudo-plasticity or thixotropy), higher viscosity, and is harder than the lower layer. The lower layer has a lower softening point, lower yield limit, less or no structural viscosity, lower viscosity, and is softer than the upper layer. Yield limit signifies the limit at which the material begins to yield when the shearing stress has reached a certain minimum value. The softening point can be defined in accordance with what is called the Wilhelmi method, which is described in the standard EN 1871:2000.

The marking is made up of a number of standard components and contains, inter alia, resin, one or more thermoplastic polymers, softeners, glass beads, pigment and filler. The percentages shown are percentages by weight unless stated otherwise.

The resin can consist to between 10 and 20% of, for example, aromatic or aliphatic hydrocarbon resins, terpene resins, coumarone/indene resin, modified/unmodified ester resins or synthetic resins, for example chlorsulphonated polyethylene, PVC and chlorinated polyethylene.

The softener content in the marking can vary up to 40% of binder included therein and can include one, or a combination of two or more, of, for example, refined mineral oil, vegetable oils, epoxidized fatty acid esters, momomeric phthalates, stearates, phosphates or polymeric softeners such as drying or nondrying alkydes. In general, the content of softener is lower for warm climates, where the marking can become too soft and yielding, while higher contents are needed in cold climates in order to achieve good durability.

Polymers, or thermoplastics, are used principally to modify the properties of the binder which can be modified for example to improve impact resistance, flexibility, durability and adhesion to glass beads. The term “binder” is used to signify the mixture of softener, polymer and resin. The content of polymer material can be 2 to 10%. Addition of a polymer material also increases the viscosity of the material at the application temperature, which means that the material's ability to shape itself to the receiving surface decreases. The thermoplastic polymer or polymers can include one or a combination of two or more of, for example, ethylene copolymers, styrene block copolymers, ionomers, amorphous polypropylene, ethyl vinyl alcohol (EVA) or elastomers of the polyamide, polyurethane or polyester type.

The total amount of binder containing the mixture of softener, polymer and resin can vary but normally lies between 15-30%. By varying the content, the marking can be given the desired properties as regards application temperature, softening point, durability, etc.

The reflecting material used is generally glass beads or similar ceramic or crystalline particles (mica, etc.) whose diameter should not exceed 1 mm (1000 μm) and is preferably between 01 and 1.0 mm (100-1000 μm) The specified sizes apply to so-called premix or intermix material, which beads are generally used for the manufacture of prefabricated markings. As regards drop-on beads, the diameter of these can exceed 1 mm, which in the first place can give the desired retroreflection in wet conditions. The refractive index of the reflecting material should preferably exceed 1.3 and is preferably 1.5-2.3. The main object of the marking is to reflect light and, as it may be exposed to substantial wear, the proportion of reflecting material can be considerable, particularly in the upper layer. The content can be up to 50%, but in most cases it is about 30%. The premix material in this case includes beads intended to give good reflection over a long period of time, with new beads being exposed as the surface becomes worm. Drop-on beads are often used for temporary road surfacings which can be removed after use, for example for traffic diversions. Such a road surfacing need only be provided with a reflecting surface sheet since there is not enough time for it to become worn to any great extent. It is of course also possible to use a road surfacing which comprises premix material in combination with drop-on material.

In addition to reflecting material, friction-enhancing material can also be added, for example particles of silicon carbide, corundum, quartz or similar hard materials with a maximum particle size of 2 mm, preferably between 0.1 and 1 mm. The content of these friction materials can be up to 5-30%.

The material can also include fillers, for example kaolin and calcium carbonate (CaCO₃) which can be added in amounts of between 10 and 50%. Such fillers can also be used to give the marking a differing colour, but are used in general in combination with different pigments. A commonly occurring pigment is titanium dioxide (TiO₂). Other types of pigments which are used for reflecting white light are zinc oxide, zinc sulphide, zirconium oxide, barium sulphate or a mixture of these. For reflecting yellow light, it is possible to use, for example bismuth vanadiate (diarylide dimethoxy chloranilide). The content of pure pigment which does not constitute a filler can be up to 15% and can in some countries be defined by local authorities. The pigment determines the colour of the marking, which as a rule is white or yellow. Other colours also occur, but the choice of colour is not relevant to the invention.

The rheology properties of the material can be influenced by different additives which can include one or a combination of, for example, talc, synthetic silicone dioxide and/or organically modified bentonite. The amount of such additives is as a rule relatively small and seldom exceeds 5%. The upper layer should have a higher viscosity and structural viscosity so that drop-on material such as glass beads and/or friction material will remain in the surface of the marking and the surface profile of the marking will retain its shape.

The thickness ratio between the different layers can vary, but for a marking comprising two layers the ratio is preferably between 1:3 and 1:7. Examples of standard sizes for road markings are 3.2 mm or alternatively 2.3 mm. According to one example, a marking with a thickness of 3.2 mm will be able to comprise a lower layer with a thickness of 0.5 mm and an upper layer with a thickness of 2.7 mm.

The marking can also include one or more further sheets or layers. An indication that the marking is beginning to become worn can be obtained using a wear-warning sheet. This sheet can have a very different colour or can be given fluorescent properties for certain wavelengths of light, for example ultraviolet light, depending on what environment the receiving surface is in or how one wishes to detect the wear. A light colour is easy to see on relatively clear roads and in daylight, which makes this solution suitable for warm climates for example. For cold climates, which as a rule have shorter periods of daylight and where the roadway can often be dirty with asphalt particles, sand, snow and ice, other methods of detection may be more suitable. A fluorescent sheet which appears on illumination with UV light can be one method of detecting wear. In cases where the upper reflecting sheet must also be able to reflect UV light, material can be used which fluoresces at different wavelengths.

The wear-warning sheet is preferably placed between the first and second layers but can also be placed on or mixed directly into the lower or upper layer, for example in the form of a pigment or the like which colours through the actual layer. In the latter case it is possible to rapidly detect wear, for example of a surface coating in the form of glass beads. Such a surface coating on the upper layer can either be part of the prefabricated coating or can be applied in situ. The sheet can also consist of a powder material with a colour which differs from that of the marking. The powder material can in this case be a plastic material which is melted into or together with the adjoining layers. By placing one or more such sheets at different levels in the upper layer, it is possible to choose at which degree of wear the sheet will warn or produce warnings of several different degrees of wear. In the latter case, several sheets with different colours are used. The upper layer is made in such cases of two or more layers of plastic material separated by the wear sheet. Alternatively, the sheet can consist of a foil of suitable material which offers good adhesion between the adjoining layers. The foil can be of plastic or metal depending on which properties are desired. A metal foil, for example of aluminium, can be detected with IR light.

Combinations of several types of sheets are of course possible, for example a first sheet of powder material combined with a coloured layer. If the upper layer becomes worn, a first warning is received when the sheet of powder material is reached, and a second warning is received when the coloured layer is reached.

According to an alternative embodiment, an indication of wear can be obtained by means of one of the layers, preferably the lower layer, being uncoloured. Such a layer, to which pigment is not added during manufacture, has a slightly brownish colour which can be seen clearly when one or more upper layers and possible intermediate sheets have become completely or partially worn.

Depending on the properties of the materials used, the application temperature, etc. the marking can in some cases include a reinforcing sheet. If the application temperature of the lower layer and the melting point of the upper layer are close to each other, a reinforcing sheet can prevent fracturing or stretching of the marking. The reinforcing sheet is preferably placed between the first layer and the second layer, but it can also be placed in the first or second layer. The reinforcing sheet preferably consists of a net or web of a suitable synthetic or metallic material, for example glass fibre, but fibres of different types, for example of the nonwoven type, can also be used. The advantage of fibres is that it is easier to reuse waste material from the manufacturing process.

The reinforcing sheet means that handling of the marking is greatly improved before application. For example, at low temperatures, there is less risk of the material breaking apart during handling. The reinforcing sheet also makes it possible to manufacture the road marking as a temporary marking, i.e. the product can be removed from the receiving surface before the marking has become worn. This type of product is preferably used for traffic diversions and similar areas.

A further function is obtained using a reinforcement in the form of a thin web or a net. A pattern of individual threads or nodes, where threads intersect or are tied, can then be transferred through the upper layer and give the latter a surface structure which increases the reflecting capacity of the surface coating. The surface structure can be influenced by a suitable choice of web or net pattern and thread or fibre thickness, and by how long and to what temperature the upper layer is heated during the manufacturing process.

According to a further embodiment, the reinforcing sheet itself can constitute a wear-warning sheet. This can be achieved by giving the reinforcing sheet a different colour or like property which means that wear can be detected (see the wear-warning sheet described above).

### DESCRIPTION OF THE FIGURES

The invention will be described in more detail below with reference to the attached figures which show diagrammatically a prefabricated road marking according to the present invention.

FIG. 1 shows a marking with two layers according to the invention.

FIG. 2 shows a marking with two layers, a reinforcing sheet and a sheet for indicating wear.

FIG. 3 shows a marking with two layers, and a sheet for indicating wear in a lower layer.

Note that the ratio of thickness between the different sheets and layers is only shown diagrammatically in the figures and does not represent the actual ratio between these.

### PREFERRED EMBODIMENTS

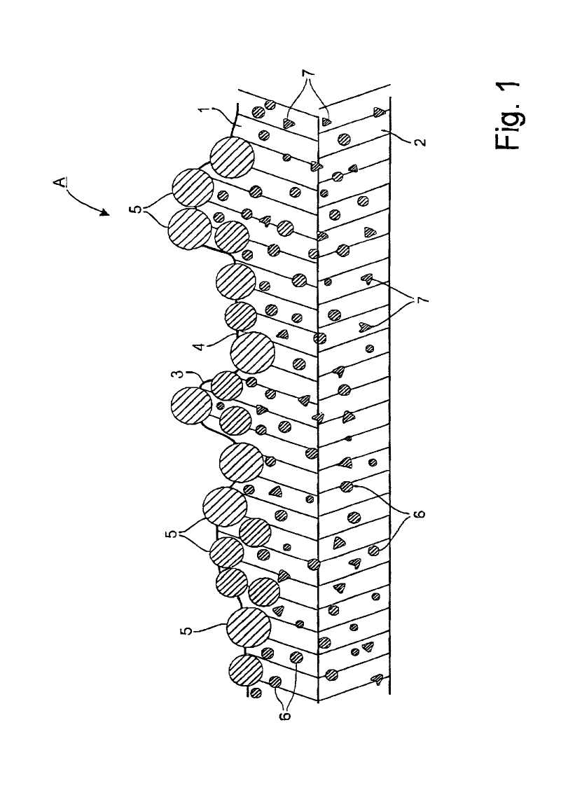

A prefabricated marking A according to the invention can be seen in FIG. 1, which shows a first, upper layer 1 in the form of a wear sheet and a second, lower layer 2 in the form of an adhesive layer. The upper layer has been provided with a number of raised areas 3 with intermediate valleys 4 and has been coated with a sheet of reflecting glass beads 5. To ensure that the marking will reflect light even when the upper sheet of glass beads has become worn after a period of time, further glass beads 6 have been admixed to the material constituting the different layers 1, 2. As the surface sheet wears down, further reflecting material is thereby exposed. The upper layer 1 preferably comprises a higher proportion of glass beads 6 than the lower layer 2, which layer is intended to adhere to a receiving surface. Both layers 1, 2 of the marking A additionally comprise friction-enhancing particles 7. In this case too, the content of particles 7 is higher in the upper layer 1. The reason why the proportion of glass beads 6 and friction-enhancing particles 7 varies between the different layers is that the marking must be able to withstand a certain degree of wear before it has to be replaced. If for some reason the marking is not replaced, it must then be able to continue to exhibit reflecting and friction-enhancing properties, despite the fact that it is actually worn. Thus, a certain amount of glass beads and particles is also added to the lower, adhesive layer 2.

Examples of an embodiment of the binder according to the invention, with its composition indicated in parts by weight, include:

EXAMPLE 1
Binder

| | | |
|---|---|---|
| Hydrocarbon resin | 15 | parts by weight |
| Low-molecular-weight | 5 | |
| hydrocarbon | | |
| Block copolymers | 3 | |
| Olefin polymer | 2 | |

As examples of an embodiment according to the inventions the following more concrete compositions of material can be used in the different layers:

EXAMPLE 2
Upper layer

| | | |
|---|---|---|
| Escorez 1102 RM ©* | 13 | parts by weight |
| ExxonMobile Chemical ™ | | |
| Enerpar 11 © | 3.0 | |
| Cariflex 1107 ©, Kraton ™ | 2.5 | |
| Escorene Mv02514 © | 2.5 | |

*softening point 100° C., viscosity 1600 at 160° C.

Lower layer

| | | |
|---|---|---|
| Escorez ECR 417 ©** | 13 | parts by weight |
| ExxonMobile Chemical ™ | | |
| Enerpar 11 © | 3.0 | |
| Cariflex 1107 ©, Kraton ™ | 2.0 | |
| Escorene Mv02514 © | 3.0 | |

*softening point 97° C., viscosity 1300 at 160° C.

The materials used in the various layers are all commercially available products.

An example of an embodiment of the invention, describing the total formulation, with the material composition in percentages, is as follows:

EXAMPLE 3

| Upper layer | | |
|---|---|---|
| Binder (as above) | 20 | Percentage |
| Premix glass beads | 30 | |
| Quartz sand | 20 | |
| Calcium carbonate | 18.5 | |
| Micro talc | 1.5 | |
| Titanium dioxide | 10 | |
| Lower layer | | |
| Binder (as above) | 30 | Percentage |
| Premix glass beads | 30 | |
| Quartz sand | 15 | |
| Calcium carbonate | 15 | |
| Titanium dioxide | 10 | |

This is of course only one variant from a very large number of possible combinations. The composition can be varied freely with respect to variables such as area of use, climate, etc., within the scope of the invention and the attached patent claims.

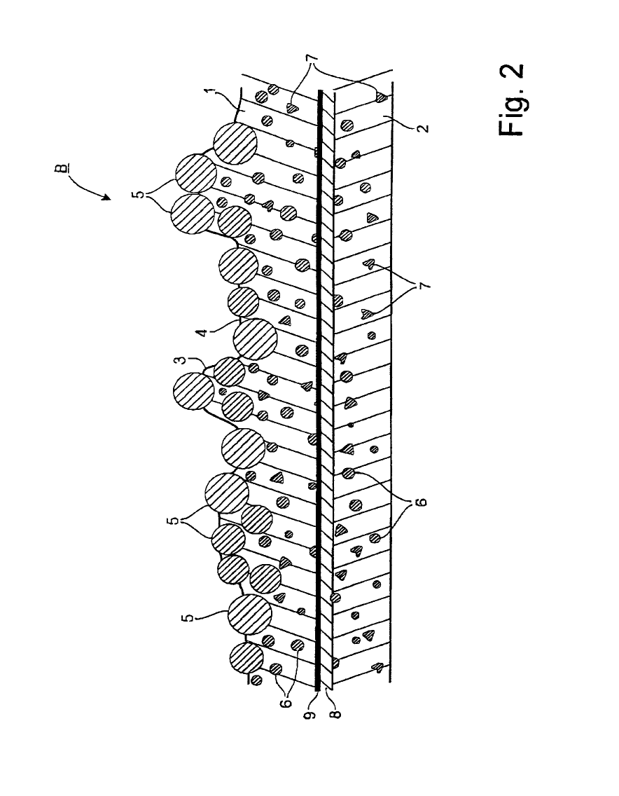

FIG. 2 shows a prefabricated marking B of the same type as has been described with reference to FIG. 1 above. This marking B is provided with a reinforcing sheet 8 consisting of glass fibre. The reinforcing sheet 8 is integrated in the marking and has been melted in between the two layers 1, 2. In the interface containing the reinforcing sheet 8, the upper layer 1 and the lower layer 2 have been melted together.

The marking B has also been provided with a sheet 9 for indicating wear, which sheet 9 is placed between the upper layer 1 and the reinforcing sheet. According to this illustrative embodiment, the indicator sheet consists of a powder material which has also been melted together with the marking at said interface. The powder material preferably consists of a coloured plastic material or pigment which forms a homogeneous sheet between the upper layer and the reinforcing sheet. The material in the indicator sheet is chosen so that it contributes to good adhesion to adjoining material sheets, since the upper and lower layers must not come loose from each other.

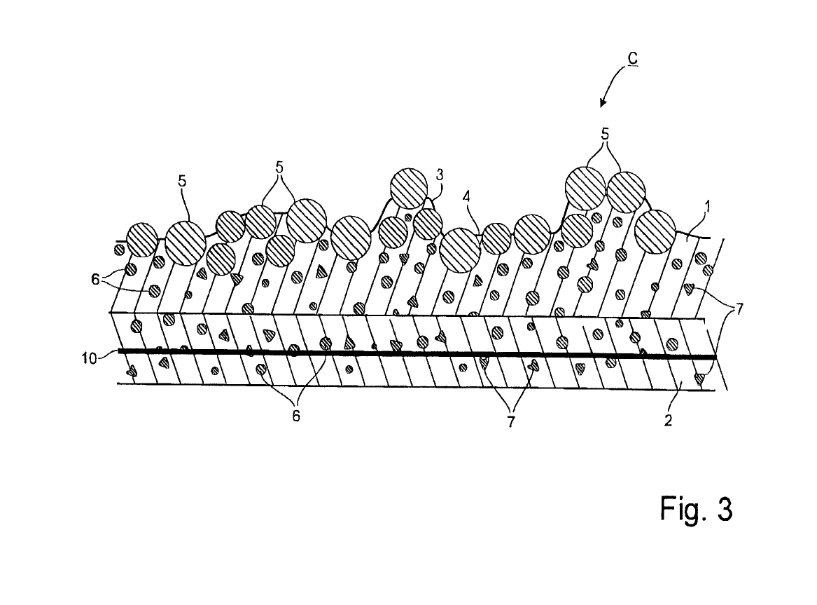

According to an alternative embodiment, which is shown in FIG. 3, a marking C has been provided with a sheet 10 for indicating wear, which sheet 10 is placed in the lower layer 2. The indicator sheet 10 has in this case been laid between a pair of sheets 2a, 2b which together constitute the lower layer 2. In this illustrative embodiment too, the indicator sheet consists of a powder material which has been melted together with the marking.

1. Surface marking for roads with a fixed road surface, such as asphalt, concrete or like receiving surface, which marking essentially comprises resin, thermoplastic polymers, softeners, reflecting material for better reflection of light, and friction material for increasing the friction between the roadway and the vehicle wheels, characterized in that the marking comprises at least two layers, of which a first, upper layer (1) constitutes a wear layer, and a second, lower layer (2) is made of a heat-activatable adhesive material.

2. Marking according to claim 1, characterized in that the lower layer (2) has an application temperature which is equal to or slightly higher than its softening point, which application temperature is lower than the application temperature for other layers.

3. Marking according to claim 1 or 2, characterized in that the properties of the upper layer are chosen with respect to the surrounding climate and area of use, and in that the properties of the lower layer are chosen with respect to optimum adhesion to a predetermined receiving surface.

4. Marking according to claim 2 or 3, characterized in that the upper layer is formable at the application temperature.

5. Marking according to any of claims 1-4, characterized in that the marking comprises a wear-warning sheet (9).

6. Marking according to claim 5, characterized in that the wear-warning sheet consists of either the upper layer or the lower layer (1, 2) which has been provided with a colouring pigment.

7. Marking according to claim 5, characterized in that the wear-warning sheet consists of the lower layer (1, 2), which is uncoloured.

8. Marking according to claim 5, characterized in that the wear-warning sheet (9) is placed between the first and second layers (1, 2).

9. Marking according to claim 5, characterized in that the wear-warning sheet (9) is placed in the first layer (1).

10. Marking according to claim 5, characterized in that the wear-warning sheet (9) is placed in the second layer (2).

11. Marking according to any of the above claims, characterized in that the marking comprises a reinforcing sheet (8).

12. Marking according to claim 11, characterized in that the reinforcing sheet (8) is placed between the first and second layers (1, 2).

13. Marking according to claim 11, characterized in that the reinforcing sheet (8) is placed in the first layer (1).

14. Marking according to any of claims 11-13, characterized in that the reinforcing sheet (8) consists of a web or a net whose structure is visible through the upper layer (1).

15. Marking according to claim 11, characterized in that the reinforcing sheet (8) is placed in the second layer (2).

16. Marking according to any of claims 11-15, characterized in that the reinforcing sheet (8) consists of a glass fibre web or a glass fibre net.
